(19) United States
(12) Patent Application Publication
(10) Pub. No.: US 2026/0010025 A1
(43) Pub. Date: Jan. 8, 2026

(54) ELECTRICALLY CONTROLLED ANTI-PEEPING DEVICE

(71) Applicant: Coretronic Corporation, Hsin-Chu (TW)

(72) Inventors: Ping-Yen Chen, Hsin-Chu (TW); Yang-Ching Lin, Hsin-Chu (TW); Chung-Yang Fang, Hsin-Chu (TW)

(73) Assignee: Coretronic Corporation, Hsin-Chu (TW)

(21) Appl. No.: 19/257,397

(22) Filed: Jul. 1, 2025

(30) Foreign Application Priority Data
Jul. 4, 2024 (CN) 202410889873.6

(51) Int. Cl. G02F 1/13; G02F 1/1333; G02F 1/1335; G02F 1/13363; G02F 1/1337; G02F 1/1339; G02F 1/1343

(52) U.S. Cl. CPC G02F 1/1323; G02F 1/133345; G02F 1/133528; G02F 1/133638; G02F 1/1337; G02F 1/13394; G02F 1/134309

(57) ABSTRACT

An electrically controlled anti-peeping device including a first substrate, a second substrate, a liquid crystal layer, a first electrode layer, a second electrode layer, a third electrode layer, a first polarizer, and a second polarizer is provided. The first substrate and the second substrate are arranged overlapping each other. The liquid crystal layer is disposed between the first substrate and the second substrate. The first electrode layer and the third electrode layer are disposed on the first substrate. The second electrode layer is disposed on the second substrate. The third electrode layer is located between the first electrode layer and the first substrate, and a projection region of the first electrode layer on the first substrate at least partially overlaps a projection region of the third electrode layer on the first substrate. The first polarizer and the second polarizer are arranged on the first substrate and the second substrate, respectively.

### CROSS-REFERENCE TO RELATED APPLICATION

This application claims the priority benefit of China application serial no. 202410889873.6, filed on Jul. 4, 2024. The entirety of the above-mentioned patent application is hereby incorporated by reference herein and made a part of this specification.

### BACKGROUND

### Technical Field

The disclosure relates to an anti-peeping technology, and more particularly, to an electrically controlled anti-peeping device.

### Description of Related Art

In general, display devices are designed to provide a wide viewing angle so that multiple viewers can watch the image simultaneously. However, in certain situations or occasions, such as browsing private webpages, confidential information, or entering passwords in public, the display effect of the wide viewing angle makes it easy for confidential information to be peeped by others, leading to leaks of confidential information. To achieve the anti-peeping effect, a common approach is to place a light control film (LCF) in front of the display panel to filter out light at large angles. Conversely, when there is no need for privacy protection, the LCF can be manually removed from in front of the display panel. In other words, although the aforementioned LCF provides privacy protection, its operational convenience still has room for improvement.

Therefore, an anti-peeping technology equipped with an electrically controlled viewing angle switching device is proposed. In general, the electrically controlled viewing angle switching device uses the electrically controllable optical properties of the liquid crystal layer to adjust the light emission angle range. However, this type of electrically controlled viewing angle switching device does not have good anti-peeping performance under low ambient light brightness. In response to this, another electrically controlled viewing angle switching device with patterned driving electrodes is proposed. At anti-peeping viewing angles, the electrically controlled viewing angle switching device displays a brightness distribution pattern, such as a checkerboard-like arrangement of bright and dark areas, to interfere with the peeping attempts from bystanders. However, when the size of the display image increases, such a design also makes it easy for users to see the checkerboard-like arrangement of bright and dark areas on the left and right sides of the display image, affecting the display effect.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

One embodiment of the disclosure provides an electrically controlled anti-peeping device. The electrically controlled anti-peeping device includes a first substrate, a second substrate, a liquid crystal layer, a first electrode layer, a second electrode layer, a third electrode layer, a first polarizer, and a second polarizer. The first substrate and the second substrate are arranged overlapping each other. The liquid crystal layer is disposed between the first substrate and the second substrate. The first electrode layer and the third electrode layer are disposed on the first substrate, and the second electrode layer is disposed on the second substrate. The third electrode layer is located between the first electrode layer and the first substrate, and a projection region of the first electrode layer on the first substrate at least partially overlaps a projection region of the third electrode layer on the first substrate. The first polarizer and the second polarizer are arranged on the first substrate and the second substrate, respectively.

One embodiment of the disclosure provides an electrically controlled anti-peeping device. The electrically controlled anti-peeping device includes a first substrate, a second substrate, a liquid crystal layer, a first electrode layer, a second electrode layer, a plurality of spacers, a first polarizer, and a second polarizer. The first substrate and the second substrate are arranged overlapping each other. The liquid crystal layer is arranged between the first substrate and the second substrate. The first electrode layer and the second electrode layer are arranged on the first substrate and the second substrate, respectively. The electrically controlled anti-peeping device has a plurality of first regions and a plurality of second regions, and the first regions and the second regions are disposed at intervals. The plurality of spacers are disposed between the first substrate and the second substrate and include a plurality of first spacers and a plurality of second spacers. Each of the plurality of first regions is provided with the plurality of first spacers. Each of the plurality of second regions is provided with the plurality of second spacers. An orthographic projection area of the plurality of first spacers on a substrate surface of the first substrate has a first ratio relative to an orthographic projection area of each first region on the substrate surface. An orthogonal projection area of the second spacers on the substrate surface has a second ratio relative to an orthogonal projection area of each second region on the substrate surface. The first ratio is different from the second ratio. The first polarizer and the second polarizer are disposed on the first substrate and the second substrate, respectively.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of an electrically controlled anti-peeping device according to a first embodiment of the disclosure.

FIG. 2 is a schematic top view of a first electrode layer and a third electrode layer of FIG. 1.

FIG. 3A to FIG. 3C are brightness distributions of the electrically controlled anti-peeping device at different viewing angles when an applied voltage of the third electrode layer of FIG. 1 is 0V.

FIG. 4A to FIG. 4C are brightness distributions of the electrically controlled anti-peeping device at different viewing angles when an applied voltage of the third electrode layer of FIG. 1 is 3.0V.

FIG. 5A to FIG. 5C are brightness distributions of the electrically controlled anti-peeping device at different viewing angles when an applied voltage of the third electrode layer of FIG. 1 is 3.8V.

FIG. 6A to FIG. 6C are brightness distributions of the electrically controlled anti-peeping device at different viewing angles when an applied voltage of the third electrode layer of FIG. 1 is 4.1V.

FIG. 7 is a schematic cross-sectional view of another modified embodiment of the third electrode layer of FIG. 1.

FIG. 8 is a schematic top view of a display device according to an embodiment of the disclosure viewed by a user and a peeper.

FIG. 9 is a schematic cross-sectional view of an electrically controlled anti-peeping device according to a second embodiment of the disclosure.

FIG. 10 is a schematic three-dimensional diagram of the first electrode layer and the third electrode layer of FIG. 9.

FIG. 11 is a schematic top view of the first electrode layer and the third electrode layer of FIG. 9.

FIG. 12A and FIG. 12B are brightness distributions seen by a user in different dimming zones when the electrically controlled anti-peeping device of FIG. 9 operates in an anti-peeping mode.

FIG. 13A and FIG. 13B are brightness distributions seen by a peeper in different dimming zones when the electrically controlled anti-peeping device of FIG. 9 operates in an anti-peeping mode.

FIG. 14 is a schematic cross-sectional view of an electrically controlled anti-peeping device of a comparative example.

FIG. 15A and FIG. 15B are brightness distributions seen by a user in different dimming zones when the electrically controlled anti-peeping device of FIG. 14 operates in an anti-peeping mode.

FIG. 16A and FIG. 16B are brightness distributions seen by a peeper in different dimming zones when the electrically controlled anti-peeping device of FIG. 14 operates in an anti-peeping mode.

FIG. 17 is a schematic top view of another modified embodiment of the first electrode layer and the third electrode layer of FIG. 11.

FIG. 18 is a schematic cross-sectional view of an electrically controlled anti-peeping device according to a third embodiment of the disclosure.

FIG. 19A to FIG. 19C are brightness distributions of a first dimming zone of the electrically controlled anti-peeping device of FIG. 18 at different viewing angles.

FIG. 20A to FIG. 20C are brightness distributions of a second dimming zone of the electrically controlled anti-peeping device of FIG. 18 at different viewing angles.

FIG. 21 is a schematic cross-sectional view of an electrically controlled anti-peeping device according to a fourth embodiment of the disclosure.

FIG. 22 is a schematic top view of an electrically controlled anti-peeping device according to a fifth embodiment of the disclosure.

FIG. 23 is a schematic cross-sectional view of an electrically controlled anti-peeping device according to a sixth embodiment of the disclosure.

FIG. 24 is a schematic cross-sectional view of an electrically controlled anti-peeping device according to a seventh embodiment of the disclosure.

FIG. 25 is a schematic diagram showing the relationship between the brightness distribution of the electrically controlled anti-peeping device of FIG. 24 and the distribution of spacers at an anti-peeping viewing angle.

FIG. 26 is a schematic cross-sectional view of an electrically controlled anti-peeping device according to an eighth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an electrically controlled anti-peeping device, which has better anti-peeping performance and greater operational flexibility.

An electrically controlled anti-peeping device of the disclosure includes a first substrate, a second substrate, a liquid crystal layer, a first electrode layer, a second electrode layer, a first polarizer and a second polarizer. The liquid crystal layer is disposed between the first substrate and the second substrate. The first electrode layer and the second electrode layer are respectively disposed on the first substrate and the second substrate. The electrically controlled anti-peeping device forms a plurality of bright areas and a plurality of dark areas when the first electrode layer and the second electrode layer are enabled, wherein at least part of the bright areas and at least part of the dark areas are alternately arranged. In order to allow a peeper to observe the plurality of bright areas and the plurality of dark areas formed by the electrically controlled anti-peeping device (operating in an anti-peeping mode) at an anti-peeping viewing angle, and to prevent a user from observing the bright areas and the dark areas, a phase retardation generated by the liquid crystal layer of the electrically controlled anti-peeping device in each bright area is different from a phase retardation generated by the liquid crystal layer in each dark area, so that the transmittance of each bright area at the anti-peeping viewing angle is greater than the transmittance of each dark area at the anti-peeping viewing angle. The specific description is as follows:

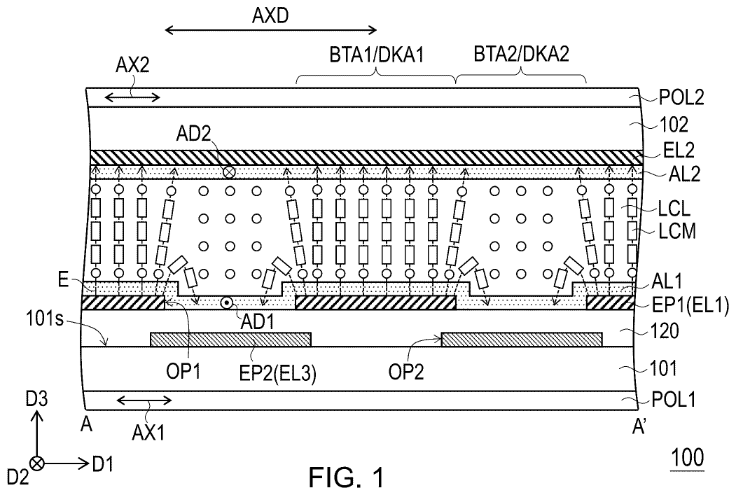

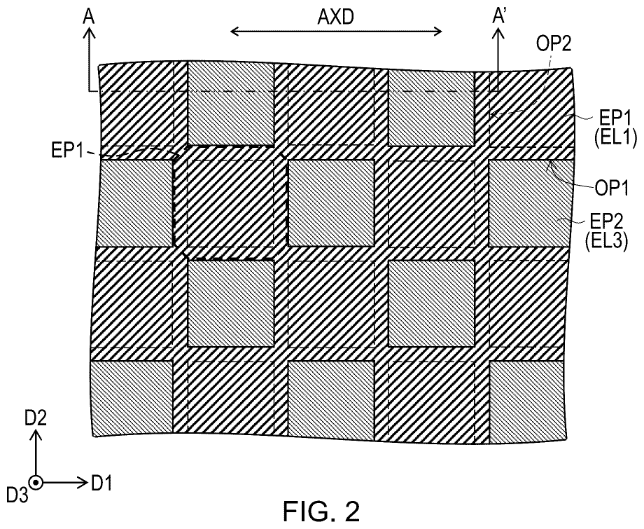

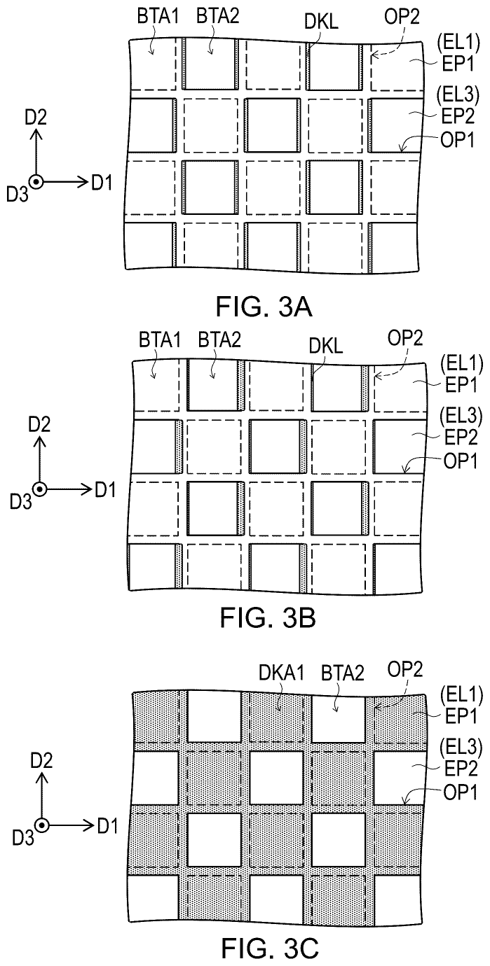

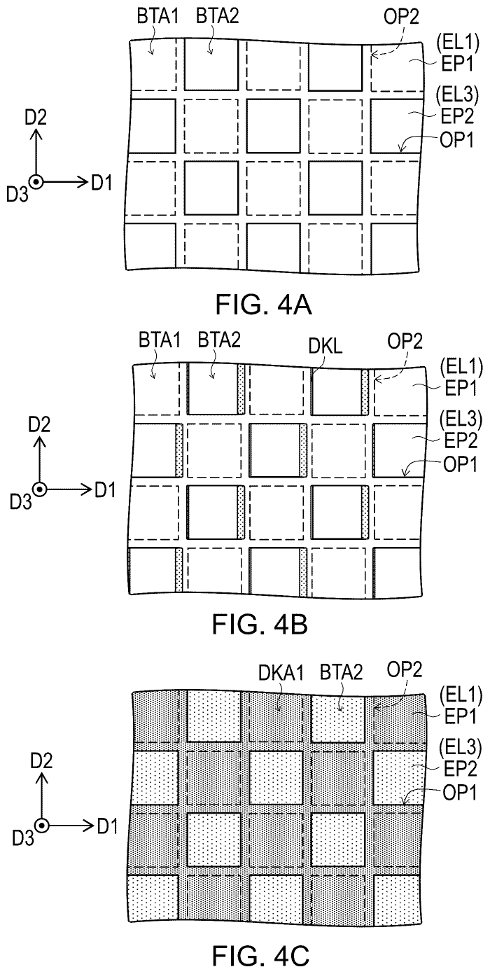

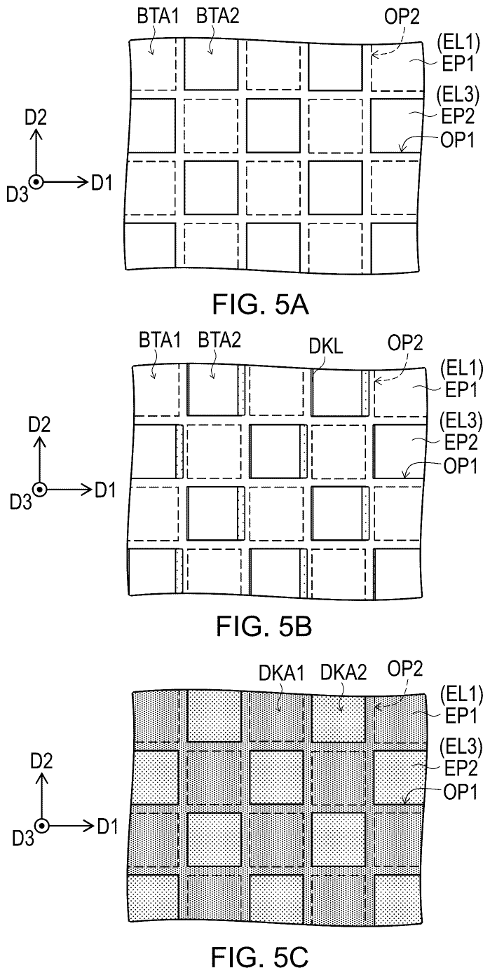

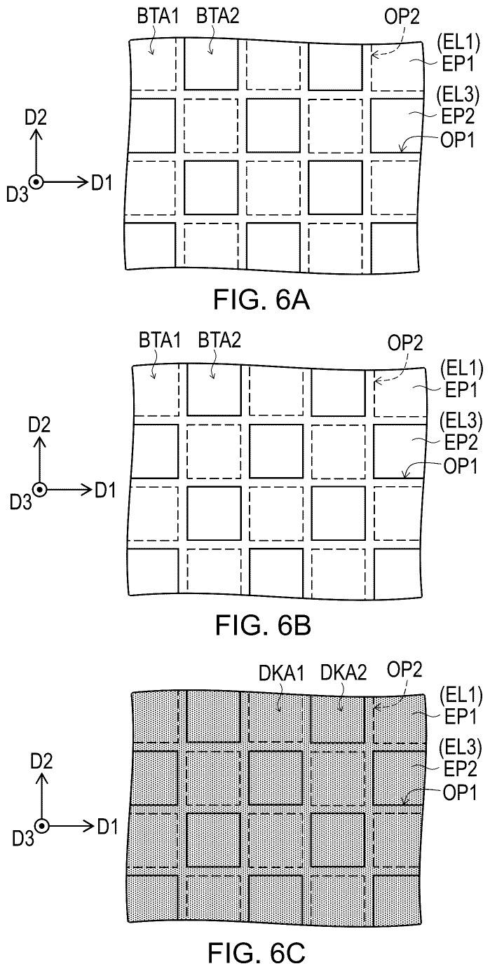

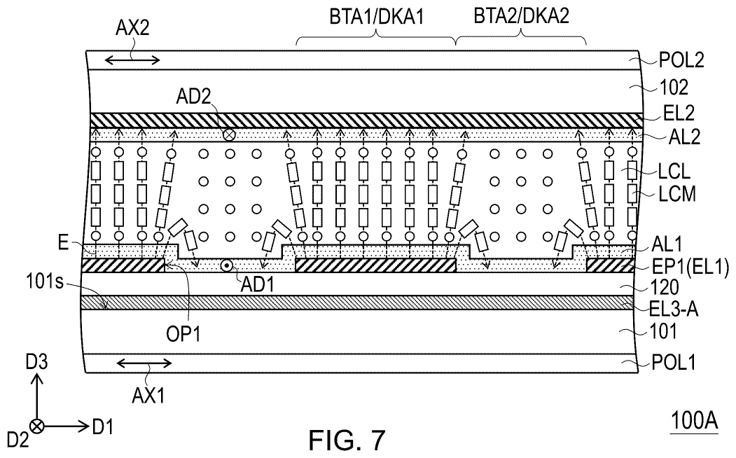

FIG. 1 is a schematic cross-sectional view of an electrically controlled anti-peeping device according to a first embodiment of the disclosure. FIG. 2 is a schematic top view of a first electrode layer and a third electrode layer of FIG. 1. FIG. 1 corresponds to a section line A-A′ of FIG. 2. FIG. 3A to FIG. 3C are brightness distributions of the electrically controlled anti-peeping device at different viewing angles when an applied voltage of the third electrode layer of FIG. 1 is 0V. FIG. 4A to FIG. 4C are brightness distributions of the electrically controlled anti-peeping device at different viewing angles when an applied voltage of the third electrode layer of FIG. 1 is 3.0V. FIG. 5A to FIG. 5C are brightness distributions of the electrically controlled anti-peeping device at different viewing angles when an applied voltage of the third electrode layer of FIG. 1 is 3.8V. FIG. 6A to FIG. 6C are brightness distributions of the electrically controlled anti-peeping device at different viewing angles when an applied voltage of the third electrode layer of FIG. 1 is 4.1V. FIG. 7 is a schematic cross-sectional view of another modified embodiment of the third electrode layer of FIG. 1.

Referring to FIG. 1 and FIG. 2, an electrically controlled anti-peeping device 100 includes a first substrate 101, a second substrate 102, a liquid crystal layer LCL, a first electrode layer EL1, a second electrode layer EL2, a first polarizer POL1 and a second polarizer POL2. The first substrate 101 and the second substrate 102 are arranged to overlap each other. The overlapping relationship herein, for example, refers to the first substrate 101 and the second substrate 102 overlapping each other along a direction D3. If not specifically mentioned below, the overlapping relationship of two components is defined in the same way, and the overlapping direction is not repeated. The materials of the first substrate 101 and the second substrate 102 include, for example, glass, triacetyl cellulose (TAC), polymethyl methacrylate (PMMA), polycarbonate (PC), polyethylene terephthalate (PET) or cycloolefin polymer (COP).

The liquid crystal layer LCL is disposed between the first substrate 101 and the second substrate 102. The first electrode layer EL1 and the second electrode layer EL2 are disposed on the first substrate 101 and the second substrate 102, respectively, and are used to drive a plurality of liquid crystal molecules LCM of the liquid crystal layer LCL to arrange, and generate different phase retardations by different arrangement states of the liquid crystal molecules LCM to produce different transmittances for a light beam. In the embodiment, the first electrode layer EL1 and the second electrode layer EL2 are, for example, light-transmitting electrodes, and the material of the light-transmitting electrodes includes metal oxides, such as indium tin oxide, indium zinc oxide, aluminum tin oxide, aluminum zinc oxide, or other suitable oxides, or a stacked layer of at least two of the above.

The first polarizer POL1 and the second polarizer POL2 are disposed on the first substrate 101 and the second substrate 102, respectively. More specifically, the first polarizer POL1 is located on a side of the first substrate 101 facing away from the liquid crystal layer LCL, and the second polarizer POL2 is located on a side of the second substrate 102 facing away from the liquid crystal layer LCL. In the embodiment, an axial direction of a first absorption axis AX1 of the first polarizer POL1 may be selectively parallel to an axial direction of a second absorption axis AX2 of the second polarizer POL2, but the disclosure is not limited thereto. In other embodiments, an included angle between the first absorption axis AX1 and the second absorption axis AX2 may be greater than 0 degrees and less than or equal to 15 degrees.

In order to allow the liquid crystal molecules LCM of the liquid crystal layer LCL to be oriented in a specific direction (specific alignment) when no external forces (such as an electric field) are applied, the electrically controlled anti-peeping device 100 further includes a first alignment layer AL1 and a second alignment layer AL2. The first alignment layer AL1 is disposed on the first substrate 101 and is located between the first electrode layer EL1 and the liquid crystal layer LCL. The second alignment layer AL2 is disposed on the second substrate 102 and is located between the second electrode layer EL2 and the liquid crystal layer LCL.

The first alignment layer AL1 and the second alignment layer AL2 have a first alignment direction AD1 and a second alignment direction AD2, respectively. In the embodiment, the first alignment direction AD1 may be antiparallel to the second alignment direction AD2. That is, an included angle between the first alignment direction AD1 and the second alignment direction AD2 is 180 degrees, but the disclosure is not limited thereto. In other embodiments, the included angle between the first alignment direction AD1 and the second alignment direction AD2 may be any angle greater than or equal to 165 degrees and less than or equal to 195 degrees. For example, in the embodiment, the liquid crystal layer LCL is driven in an electrically controlled birefringence (ECB) mode, but the disclosure is not limited thereto.

In the embodiment, the first alignment direction AD1 or the second alignment direction AD2 may be parallel to a direction D2 (for example, the projection of the directions on the first substrate 101), and the first absorption axis AX1 of the first polarizer POL1 and the second absorption axis AX2 of the second polarizer POL2 may be parallel to the direction D1. The directions D1, D2 and D3 may be selectively perpendicular to each other, and the directions D1 and D2 are, for example, parallel to a substrate surface 101s of the first substrate 101. In other words, in the embodiment, the alignment direction (for example, the projection on the first substrate 101) of the alignment layer is perpendicular to the axial direction of the absorption axis of the polarizer, but the disclosure is not limited thereto. In other embodiments, the alignment direction of the alignment layer may be parallel to the axial direction of the absorption axis of the polarizer.

It is particularly noted that the alignment direction of the alignment layer can define an anti-peeping control axial direction AXD of the electrically controlled anti-peeping device 100. More specifically, the anti-peeping control axial direction AXD is perpendicular to the first alignment direction AD1 (or perpendicular to the first alignment direction AD1 and the second alignment direction AD2). That is, the anti-peeping control axial direction AXD of the embodiment is parallel to the direction D1.

Furthermore, in the embodiment, the first electrode layer EL may have a plurality of first electrode patterns EP1 electrically connected to each other and a plurality of first openings OP1 spaced apart from each other. For example, the plurality of first electrode patterns EP1 and the plurality of first openings OP1 may be arranged alternately along the direction D1 and the direction D2, respectively, to form a checkerboard-like distribution (as shown in FIG. 2). However, the disclosure is not limited thereto. In other embodiments, an orthographic projection profile of the first electrode pattern on the substrate surface 101s of the first substrate 101 may also be a rhombus, a circle, or a specific logo pattern. The second electrode layer EL2 is, for example, a surface electrode (i.e., an unpatterned electrode), entirely covering a viewing area of the second substrate 102.

Referring to FIG. 1, FIG. 2 and FIG. 3C, when the first electrode layer EL1 and the second electrode layer EL2 are enabled (for example, a voltage of 3.3V is applied to the first electrode layer EL1 and the second electrode layer EL2 is grounded), an electric field E generated between the plurality of first electrode patterns EP1 and the second electrode layer EL2 can drive the liquid crystal molecules LCM of a part of the liquid crystal layer LCL overlapping the first electrode patterns EP1 to rotate. The arrangement state of the liquid crystal molecules LCM of another part of the liquid crystal layer LCL overlapping the first openings OP1 remains unchanged because it is not affected by the electric field E. Therefore, the phase retardations of the two regions are different. At this time, the electrically controlled anti-peeping device 100 will form a plurality of dark areas DKA1 and a plurality of bright areas BTA2 (as shown in FIG. 3C) at an anti-peeping viewing angle (for example, 45 degrees). These dark areas DKA1 correspond to the plurality of first electrode patterns EP1 of the first electrode layer EL1 respectively. These bright areas BTA2 correspond to the plurality of first openings OP1 of the first electrode layer EL1 respectively. That is to say, the electrically controlled anti-peeping device 100 operating in an anti-peeping mode forms a checkerboard-like brightness distribution at the anti-peeping viewing angle.

It should be noted first that the electronically controlled anti-peeping device 100 of the embodiment is used to overlap a display surface of a display panel (not shown), for example, it is disposed on a display side of a self-luminous (or non-self-luminous) display panel or a back side of a non-self-luminous display panel to provide anti-peeping display for users. The shielding pattern (i.e., the aforementioned checkerboard-like brightness distribution) formed by the electronically controlled anti-peeping device 100 operating in the anti-peeping mode at the anti-peeping viewing angle can be used to block a portion of the display image displayed by the display panel, thereby interfering with side viewing and achieve an anti-peeping effect.

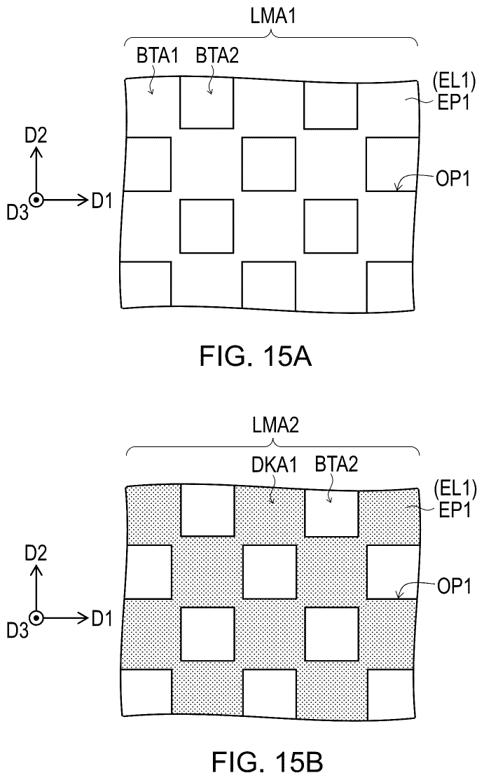

However, when the electronically controlled anti-peeping device 100 forms a checkerboard-like brightness distribution at the anti-peeping viewing angle, it may also form a plurality of dark lines (such as the dot areas in FIG. 3A and FIG. 3B) and a plurality of bright areas at the non-anti-peeping viewing angles (such as 0 degrees in FIG. 3A and 15 degrees in FIG. 3B). For example, FIG. 3A and FIG. 3B respectively show the brightness distribution of the electronically controlled anti-peeping device 100 operating in the anti-peeping mode at a viewing angle of 0 degrees (i.e., a normal viewing angle) and a viewing angle of 15 degrees. As shown in FIG. 3A and FIG. 3B, dark lines DKL are formed at two opposite side edges of the first electrode pattern EP1 along the direction D1 (i.e., the anti-peeping control axial direction AXD in FIG. 2), and the dark lines DKL become more obvious as the viewing angle increases.

That is, when the first electrode layer EL1 and the second electrode layer EL2 are enabled, although the electrically controlled anti-peeping device 100 can produce an excellent anti-peeping effect at an anti-peeping viewing angle, it will simultaneously form a dark line DKL distribution that interferes with the user's viewing of the display image at a non-anti-peeping viewing angle. In order to solve this problem, the electrically controlled anti-peeping device 100 may further include a third electrode layer EL3. The third electrode layer EL3 is disposed on the first substrate 101 and is located between the first electrode layer EL1 and the first substrate 101. An insulation layer 120 is provided between the first electrode layer EL1 and the third electrode layer EL3, that is, the first electrode layer EL1 and the third electrode layer EL3 are electrically separated. The first electrode layer EL1 and the third electrode layer EL3 are, for example, located on two opposite side surfaces of the insulation layer 120, and a surface of the insulation layer 120 away from the first substrate 101 (the surface on which the first electrode layer EL1 is provided) is, for example, a plane, but the disclosure is not limited thereto. In one embodiment, there is a gap between the projection areas of the first electrode layer EL1 and the third electrode layer EL3 on a plane perpendicular to the anti-peeping control axial direction AXD (e.g., a plane parallel to the directions D2 and D3) (i.e., the projection areas do not overlap each other).

Referring to FIG. 1 and FIG. 2, it is particularly noted that a projection region of the third electrode layer EL3 on the first substrate 101 at least partially overlaps a projection region of the first electrode layer on the first substrate 101. In the embodiment, the third electrode layer EL3 may have a plurality of second electrode patterns EP2 electrically connected to each other and a plurality of second openings OP2 spaced apart from each other. These second electrode patterns EP2 and these second openings OP2 may be arranged alternately along the direction D1 and the direction D2, respectively, to form a checkerboard-like distribution (as shown in FIG. 2), but the disclosure is not limited thereto. In other embodiments, the third electrode layer EL3-A of the electrically controlled anti-peeping device 100A may be an unpatterned electrode layer (as shown in FIG. 7), that is, the orthographic projections of the plurality of first electrode patterns EP1 and the plurality of first openings OP1 of the first electrode layer EL1 on the substrate surface 101s of the first substrate 101 are located within an orthographic projection of the third electrode layer EL3-A on the substrate surface 101s.

From another point of view, in the embodiment, the plurality of first electrode patterns EP1 of the first electrode layer EL1 overlap the plurality of second openings OP2 of the third electrode layer EL3, respectively, and the plurality of second electrode patterns EP2 of the third electrode layer EL3 overlap the plurality of first openings OP1 of the first electrode layer EL1, respectively. The plurality of first electrode patterns EP1 partially overlap the plurality of second electrode patterns EP2. In one embodiment, a geometric center of the first electrode pattern EP1, for example, overlaps a corresponding second opening OP2, and a geometric center of the second electrode pattern EP2, for example, overlaps a corresponding first opening OP1.

For example, when the electrically controlled anti-peeping device 100 operates in the anti-peeping mode, a voltage of 3.3V may be applied to the first electrode layer EL1, and the second electrode layer EL2 is grounded. At this time, if a voltage of 3.0V is applied to the third electrode layer EL3, the brightness distribution of the electrically controlled anti-peeping device 100 at a viewing angle of 0 degrees (as shown in FIG. 4A) will not have the dark lines DKL shown in FIG. 3A. Although the brightness distribution of the electrically controlled anti-peeping device 100 at a viewing angle of 15 degrees still has the dark lines DKL, the visibility of the dark lines DKL may be further suppressed (as shown in FIG. 3B and FIG. 4B).

It is particularly noted that, at this time, the brightness of the bright area BTA2 (as shown in FIG. 4C) formed by the electrically controlled anti-peeping device 100 at the anti-peeping viewing angle (e.g., 45 degrees) is lower than the brightness of the bright area BTA2 (as shown in FIG. 3C) when the third electrode layer EL3 is not enabled or grounded, thereby further improving the anti-peeping effect.

If the applied voltage of the third electrode layer EL3 is further increased to 3.8V or 4.1V, the electrically controlled anti-peeping device 100 can still maintain the uniformity of its brightness distribution at a viewing angle of 0 degrees (as shown in FIG. 5A and FIG. 6A). At this time, the visibility of the dark lines DKL formed in the brightness distribution of the electrically controlled anti-peeping device 100 at a viewing angle of 15 degrees may be further suppressed (as shown in FIG. 5B) or even eliminated (as shown in FIG. 6B).

It is particularly noted that a portion (overlapping the second electrode pattern EP2) of the brightness distribution of the electrically controlled anti-peeping device 100 at a viewing angle of 45 degrees (i.e., the anti-peeping viewing angle) forms another dark area DKA2 (as shown in FIG. 5C and FIG. 6C) because the brightness is close to the brightness of the dark area DKA1. In other words, the electrically controlled anti-peeping device 100 has formed a nearly all-black brightness distribution at the anti-peeping viewing angle, i.e., it does not have a checkerboard-like anti-peeping pattern. In the embodiment, there is a first electric field distribution between the third electrode layer EL3 and the second electrode layer EL2, and there is a second electric field distribution between the first electrode layer EL1 and the second electrode layer EL2. The phase retardation effect produced by the first electric field distribution on the liquid crystal layer is similar to the phase retardation effect produced by the second electric field distribution on the liquid crystal layer.

From the foregoing, it can be seen that since the phase retardation generated by the liquid crystal layer LCL of the electrically controlled anti-peeping device 100 in each bright area BTA2 is different from the phase retardation generated in each dark area DKA1, the transmittance of each bright area BTA2 at the anti-peeping viewing angle is greater than the transmittance of each dark area DKA1 at the anti-peeping viewing angle, and through the configuration of the third electrode layer EL3 and the adjustment of its voltage, not only the visual quality experienced by the user of the electrically controlled anti-peeping device 100 in the anti-peeping mode can be effectively improved, but the anti-peeping performance of the electrically controlled anti-peeping device 100 can also be improved simultaneously.

Some other embodiments are provided below to describe the disclosure in detail, where the same reference numerals denote the same or like components, and descriptions of the same technical contents are omitted. The aforementioned embodiment may be referred for descriptions of the omitted parts, and detailed descriptions thereof are not repeated in the following embodiment.

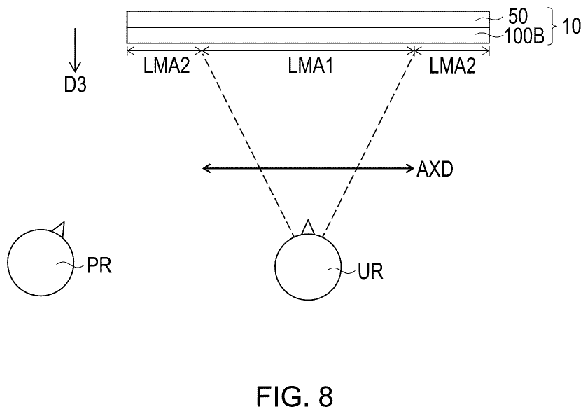

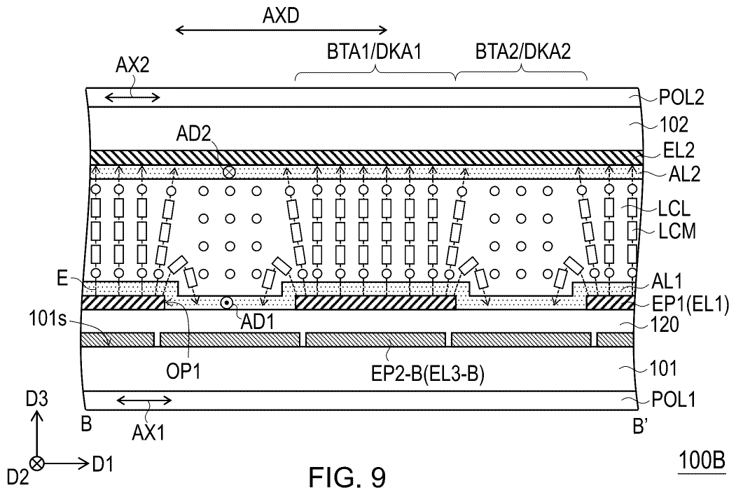

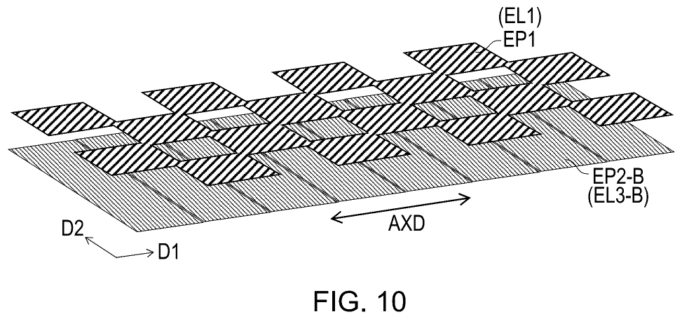

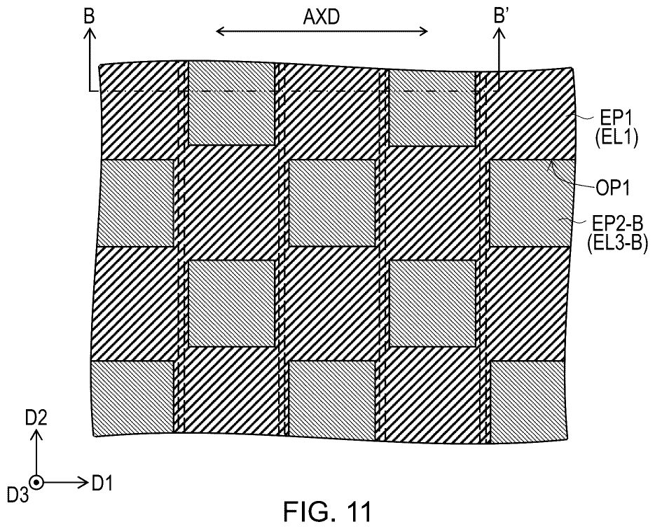

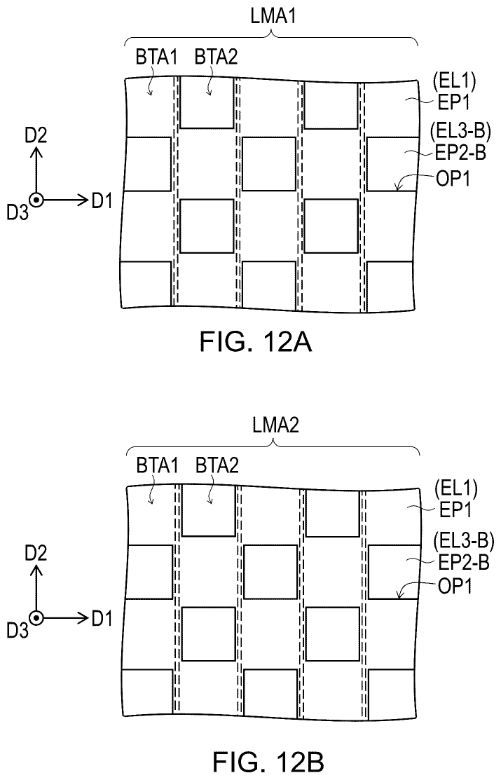

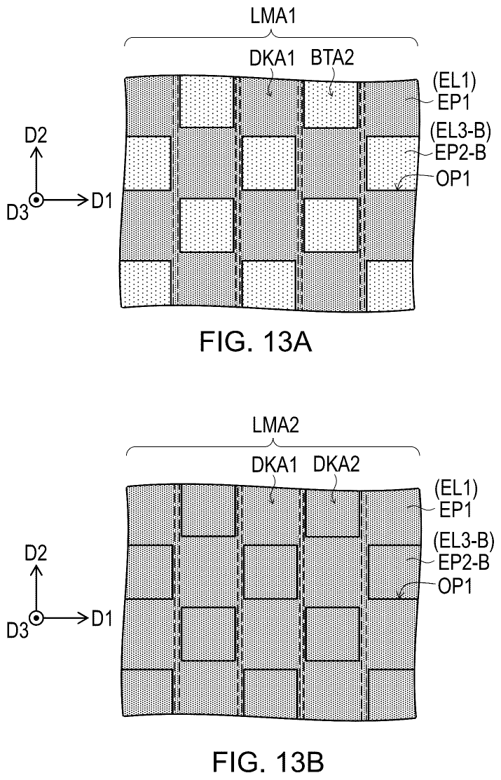

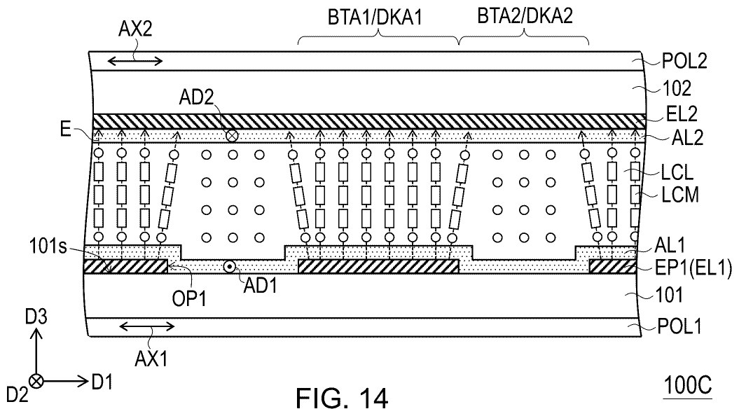

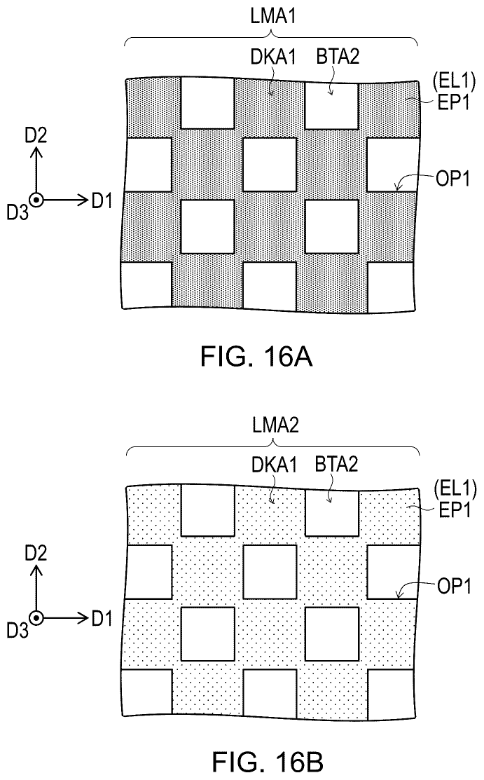

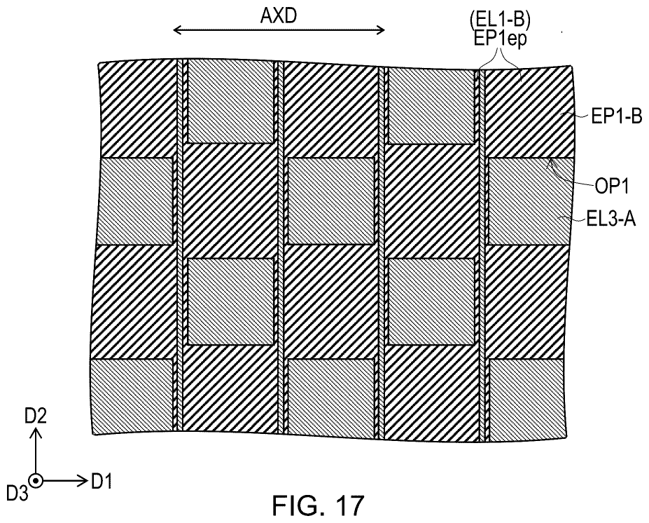

FIG. 8 is a schematic top view of a display device according to an embodiment of the disclosure viewed by a user and a peeper. FIG. 9 is a schematic cross-sectional view of an electrically controlled anti-peeping device according to a second embodiment of the disclosure. FIG. 9 corresponds to a section line B-B′ of FIG. 11. FIG. 10 is a schematic three-dimensional diagram of the first electrode layer and the third electrode layer of FIG. 9. FIG. 11 is a schematic top view of the first electrode layer and the third electrode layer of FIG. 9. FIG. 12A and FIG. 12B are brightness distributions seen by a user in different dimming zones when the electrically controlled anti-peeping device of FIG. 9 operates in an anti-peeping mode. FIG. 13A and FIG. 13B are brightness distributions seen by a peeper in different dimming zones when the electrically controlled anti-peeping device of FIG. 9 operates in an anti-peeping mode. FIG. 14 is a schematic cross-sectional view of an electrically controlled anti-peeping device of a comparative example. FIG. 15A and FIG. 15B are brightness distributions seen by a user in different dimming zones when the electrically controlled anti-peeping device of FIG. 14 operates in an anti-peeping mode. FIG. 16A and FIG. 16B are brightness distributions seen by a peeper in different dimming zones when the electrically controlled anti-peeping device of FIG. 14 operates in an anti-peeping mode. FIG. 17 is a schematic top view of another modified embodiment of the first electrode layer and the third electrode layer of FIG. 11.

Referring to FIG. 8 and FIG. 9, the difference between an electrically controlled anti-peeping device 100B of the embodiment and the electrically controlled anti-peeping device 100 of FIG. 1 lies in that the design of the third electrode layer is different. Specifically, in the electrically controlled anti-peeping device 100B of the embodiment, the third electrode layer EL3-B may have a plurality of second electrode patterns EP2-B electrically separated from each other. It is particularly noted that the second electrode patterns EP2-B are arranged along the anti-peeping control axial direction AXD of the electrically controlled anti-peeping device 100B and extend in a direction (e.g., direction D2) perpendicular to the anti-peeping control axial direction AXD (as shown in FIG. 10 and FIG. 11).

However, the disclosure is not limited thereto. In another modified embodiment, the third electrode layer EL3-A is not patterned, and the first electrode layer EL1-B is divided into a plurality of electrode portions EP1ep electrically separated from each other (as shown in FIG. 17). These electrode portions EP1ep are arranged along the anti-peeping control axial direction AXD and extend in a direction (e.g., direction D2) perpendicular to the anti-peeping control axial direction AXD. Each electrode portion EP1ep is provided with a part of the plurality of first electrode patterns EP1-B and a part of the plurality of first openings OP1.

In the embodiment, the electrically controlled anti-peeping device 100B is used to be disposed on a display side of a display panel 50 to form a display device 10 with an anti-peeping function. The electrically controlled anti-peeping device 100B is provided with a first dimming zone LMA1 and a second dimming zone LMA2 located on two opposite sides of the first dimming zone LMA1 along the anti-peeping control axial direction AXD. To clarify first, the plurality of second electrode patterns EP2-B electrically separated from each other allow the third electrode layer EL3-B to be applied with different voltages in the first dimming zone LMA1 and the second dimming zone LMA2.

The difference between an electrically controlled anti-peeping device 100C of a comparative example in FIG. 14 and the electrically controlled anti-peeping device 100B of the embodiment lies in that the electrically controlled anti-peeping device 100C of the comparative example is not provided with the third electrode layer EL3-B of FIG. 9. For example, when the user UR is in a direct viewing position (as shown in FIG. 8) relative to the display device (e.g., 532.3 mm away from the display device) and views the image displayed by the display panel 50 through the electrically controlled anti-peeping device 100C, both the parts of the brightness distribution formed by the electrically controlled anti-peeping device 100C in the first dimming zone LMA1 and overlapped with the first electrode pattern EP1 and the first opening OP1 are bright areas (bright area BTA1 and bright area BTA2 as shown in FIG. 15A). In other words, the user UR can see the image displayed by the display panel 50 through the first dimming zone LMA1 without interference.

However, if the screen size is too large (for example, larger than 14 inches), the user UR will see an anti-peeping pattern (as shown in FIG. 15B) consisting of a plurality of dark areas DKA1 and a plurality of bright areas BTA2 arranged alternately in the areas (for example, areas with a viewing angle greater than 15 degrees, i.e., the second dimming zone LMA2) on opposite sides of the image along the anti-peeping control axial direction AXD, which affects the viewing of the image.

On the other hand, for a peeper PR, when the peeper PR views the image through the electrically controlled anti-peeping device 100C of the comparative example at a larger viewing angle (for example, 45 degrees), the electrically controlled anti-peeping device 100C will form an anti-peeping pattern (as shown in FIG. 16A) consisting of a plurality of dark areas DKA1 and a plurality of bright areas BTA2 arranged alternately in the first dimming zone LMA1, so as to interfere with the viewing of the peeper PR.

In order to solve the problem of the above-mentioned image size being too large in the anti-peeping mode (for the user UR), the second electrode pattern EP2-B of the electrically controlled anti-peeping device 100B of the embodiment located in the first dimming zone LMA1 may be applied with a voltage of 3.3V, and the second electrode pattern EP2-B in the second dimming zone LMA2 may be applied with a voltage of 4.1V. Accordingly, as shown in FIG. 12A and FIG. 12B, in addition to maintaining the see-through effect in the first dimming zone LMA1, the user UR will not see the anti-peeping pattern shown in FIG. 15B in the second dimming zone LMA2, which helps to improve the visual quality of the user UR.

On the other hand, under the aforementioned voltage setting, the peeper PR will still see the anti-peeping pattern formed by the plurality of bright areas BTA2 and the plurality of dark areas DKA1 alternately arranged in the first dimming zone LMA1 (as shown in FIG. 13A). However, the peeper PR will see a nearly all-black brightness distribution (as shown in FIG. 13B) formed by the plurality of dark areas DKA1 and the plurality of dark areas DKA2 in the second dimming zone LMA2 (i.e., the anti-peeping pattern is not checkerboard-like) and is unable to view the image. In this way, the problem of the electronically controlled anti-peeping device 100C of the aforementioned comparative example failing to provide anti-peeping effect in the second dimming zone LMA2 closer to the peeper PR due to the excessively large size of image can be improved.

From the foregoing, it can be seen that the configuration of the plurality of second electrode patterns EP2-B of the third electrode layer EL3-B and the characteristic that their voltages can be individually adjusted, not only the visual quality of the electronically controlled anti-peeping device 100B in the anti-peeping mode for the user can be effectively improved, but the anti-peeping performance of the electronically controlled anti-peeping device 100B can also be enhanced simultaneously.

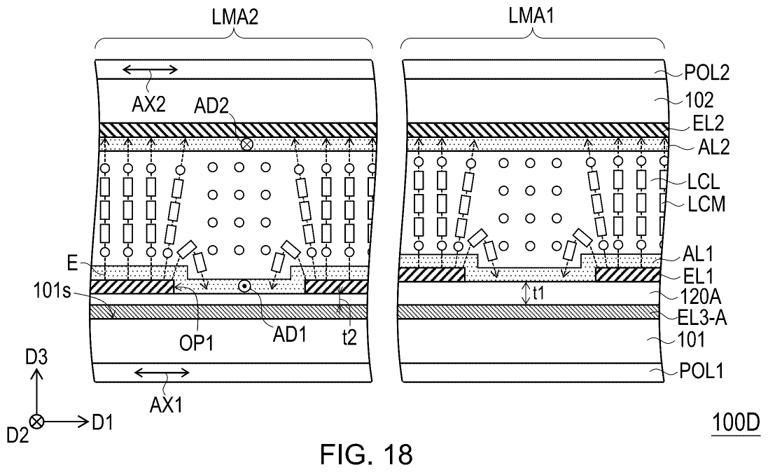

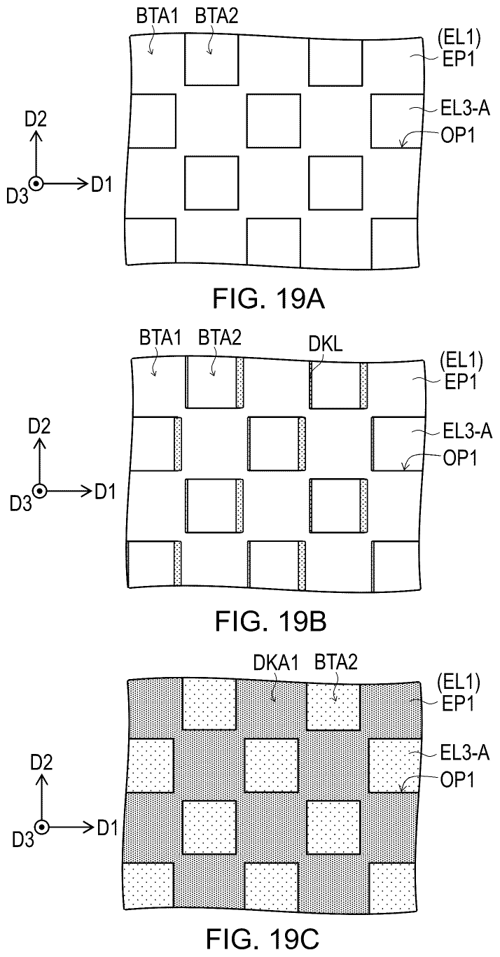

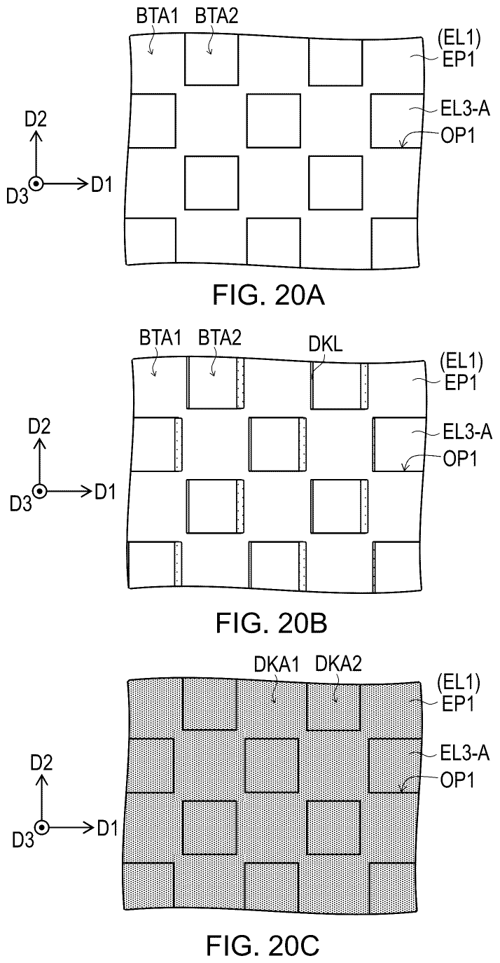

FIG. 18 is a schematic cross-sectional view of an electrically controlled anti-peeping device according to a third embodiment of the disclosure. FIG. 19A to FIG. 19C are brightness distributions of a first dimming zone of the electrically controlled anti-peeping device of FIG. 18 at different viewing angles. FIG. 20A to FIG. 20C are brightness distributions of a second dimming zone of the electrically controlled anti-peeping device of FIG. 18 at different viewing angles.

Referring to FIG. 18, the difference between the electrically controlled anti-peeping device 100D of the embodiment and the electrically controlled anti-peeping device 100A of FIG. 7 lies in that the insulation layer between the first electrode layer and the third electrode layer is configured differently. Specifically, in the electrically controlled anti-peeping device 100D of the embodiment, the thickness of the insulation layer 120A between the first electrode layer EL1 and the third electrode layer EL3-A is different in the first dimming zone LMA1 compared to the second dimming zone LMA2.

It should be noted first that when the electronically controlled anti-peeping device 100D is operated in the anti-peeping mode, the brightness distribution generated at each viewing angle will change with the thickness of the insulation layer 120A. FIG. 19A to FIG. 19C show the brightness distributions of the electronically controlled anti-peeping device 100D displayed at different viewing angles when the thickness of the insulation layer 120A is 1.53 mm. FIG. 20A to FIG. 20C show the brightness distributions of the electronically controlled anti-peeping device 100D displayed at different viewing angles when the thickness of the insulation layer 120A is 0.3 mm.

For example, in the anti-peeping mode, the first electrode layer EL1 and the third electrode layer EL3-A are both applied with a voltage of 3.3V. At this time, if the thickness of the insulation layer 120A is reduced from 1.53 mm to 0.3 mm, the brightness distribution generated by the electrically controlled anti-peeping device 100D at a viewing angle of 0 degrees will not change substantially (as shown in FIG. 19A and FIG. 20A). However, the dark lines DKL in the brightness distribution generated by the electrically controlled anti-peeping device 100D at a viewing angle of 15 degrees will be further suppressed (as shown in FIG. 20B), and the brightness distribution generated by the electrically controlled anti-peeping device 100D at a viewing angle of 45 degrees (i.e., the anti-peeping viewing angle) will be transformed from an anti-peeping pattern formed by the plurality of dark areas DKA1 and the plurality of bright areas BTA2 alternately arranged (as shown in FIG. 19C) to a nearly all-black brightness distribution consisting of the plurality of dark areas DKA1 and the plurality of dark areas DKA2 (as shown in FIG. 20C, i.e., the anti-peeping pattern is not checkerboard-like).

It can be seen from the above description that if a second thickness t2 of the insulation layer 120A in the second dimming zone LMA2 is designed to be smaller than a first thickness t1 of the insulation layer 120A in the first dimming zone LMA1 (for example, the first thickness t1 is 1.53 mm, and the second thickness t2 is 0.3 mm), the electrically controlled anti-peeping device 100D of the embodiment can also improve the issues of reduced visual quality of the user and anti-peeping failure in the second dimming zone LMA2 when the image is too large in the aforementioned embodiment.

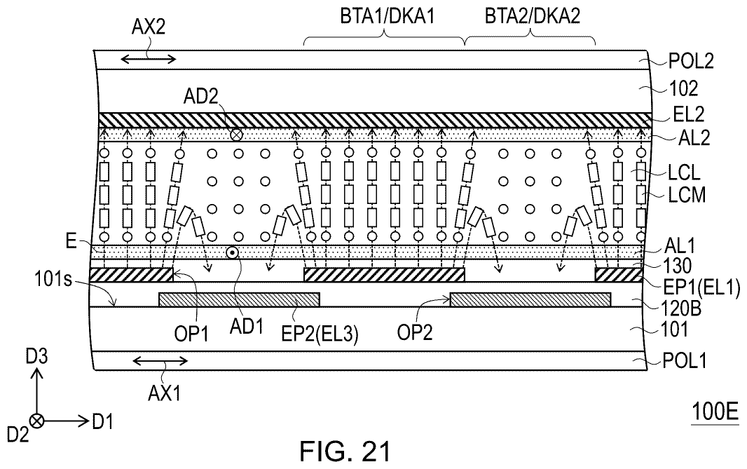

FIG. 21 is a schematic cross-sectional view of an electrically controlled anti-peeping device according to a fourth embodiment of the disclosure. Referring to FIG. 21, the difference between the electrically controlled anti-peeping device 100E of the embodiment and the electrically controlled anti-peeping device 100 of FIG. 1 lies in that the different number of insulation layers and their additional functionality. Specifically, in the embodiment, another planarization layer 130 (insulation layer) is further provided between the first alignment layer AL1 and the first electrode layer EL1, and the planarization layer 130 directly covers the plurality of first electrode patterns EP1 of the first electrode layer EL1.

For example, in the embodiment, a refractive index difference between the first electrode layer EL1 and the planarization layer 130 may be less than or equal to 0.3, and a refractive index difference between the third electrode layer EL3 and the insulation layer 120B may be less than or equal to 0.3. More specifically, the insulation layer 120B and the planarization layer 130 of the embodiment may also be index matching layers. Accordingly, the visibility of the plurality of first electrode patterns EP1 of the first electrode layer EL1 and the plurality of second electrode patterns EP2 of the third electrode layer EL3 may be reduced.

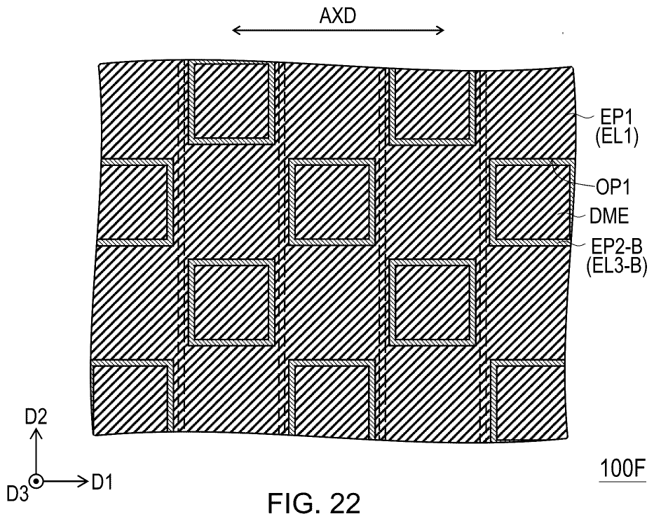

FIG. 22 is a schematic top view of an electrically controlled anti-peeping device according to a fifth embodiment of the disclosure. Referring to FIG. 22, unlike the electrically controlled anti-peeping device 100B of FIG. 9 and FIG. 11, in an electrically controlled anti-peeping device 100F of the embodiment, a plurality of dummy electrodes DME may be respectively disposed in the plurality of first openings OP1 of the first electrode layer EL1, and the dummy electrodes DME are electrically separated from the first electrode layer EL1. For example, the dummy electrodes DME may have a floating potential.

Through the configuration of the plurality of dummy electrodes DME, the visibility of the plurality of first electrode patterns EP1 of the first electrode layer EL1 can be reduced. Since the other components of the electrically controlled anti-peeping device 100F of the embodiment are similar to the electrically controlled anti-peeping device 100B of FIG. 9, the illustration and description of the other components can refer to the relevant paragraphs and drawings of the aforementioned embodiment, and will not be repeated here.

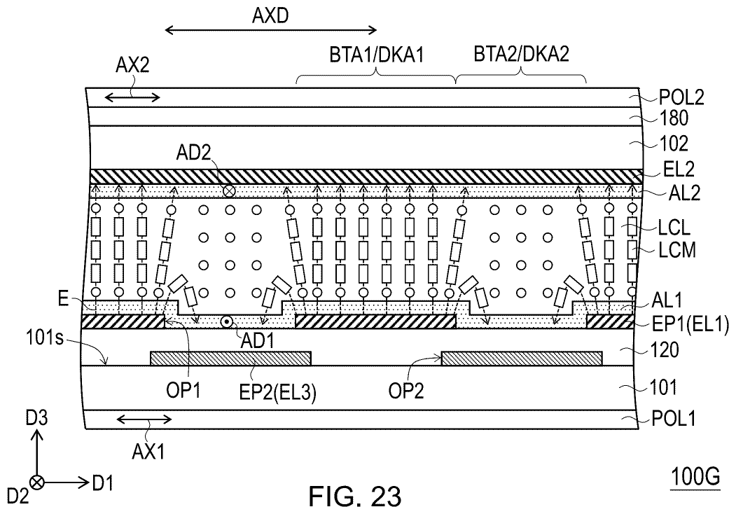

FIG. 23 is a schematic cross-sectional view of an electrically controlled anti-peeping device according to a sixth embodiment of the disclosure. Referring to FIG. 23, compared to the electrically controlled anti-peeping device 100 of FIG. 1, an electrically controlled anti-peeping device 100G of the embodiment further includes a compensation film 180 disposed between the first polarizer POL1 and the second polarizer POL2. For example, in the embodiment, the compensation film 180 may be disposed between the second polarizer POL2 and the liquid crystal layer LCL, but the disclosure is not limited thereto. In other embodiments, the compensation film 180 may be disposed between the first polarizer POL1 and the liquid crystal layer LCL. Preferably, the out-of-plane phase retardation (Rth) of the compensation film 180 may be greater than or equal to 200 nm and less than or equal to 1000 nm, but the disclosure is not limited thereto.

Making the liquid crystal layer of the electronically controlled anti-peeping device produce different phase retardations in different regions is not limited to the above method, and different phase retardations can be produced in different regions by adjusting the thickness of the liquid crystal layer. The detailed description is as follows:

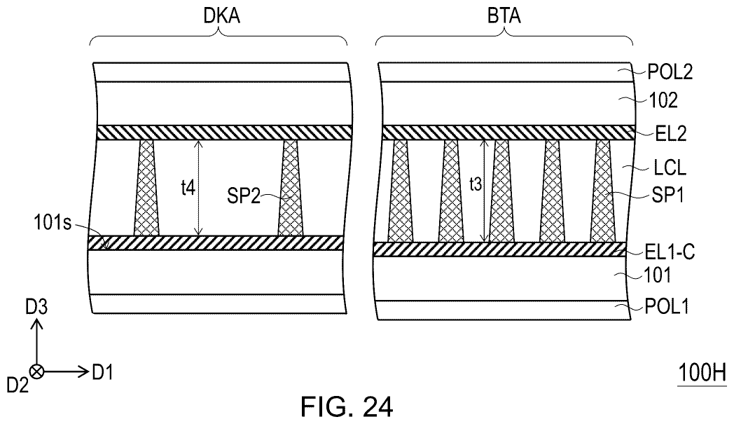

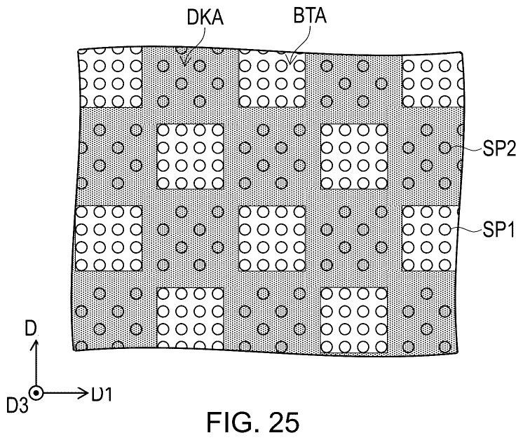

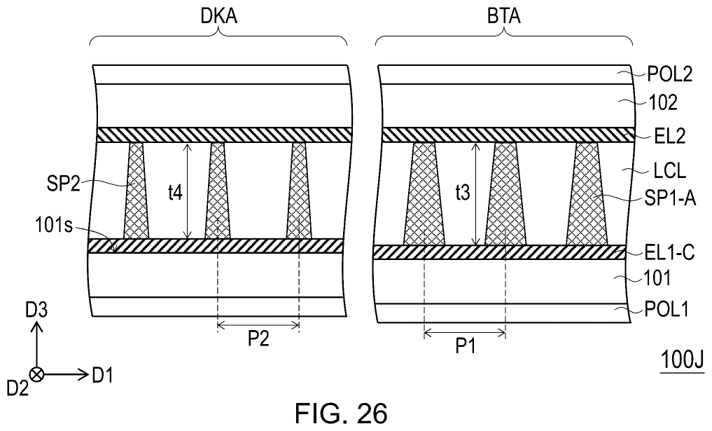

FIG. 24 is a schematic cross-sectional view of an electrically controlled anti-peeping device according to a seventh embodiment of the disclosure. FIG. 25 is a schematic diagram showing the relationship between the brightness distribution of the electrically controlled anti-peeping device of FIG. 24 and the distribution of spacers at an anti-peeping viewing angle. FIG. 26 is a schematic cross-sectional view of an electrically controlled anti-peeping device according to an eighth embodiment of the disclosure.

Referring to FIG. 24 and FIG. 25, in the embodiment, the first electrode layer EL1-C of an electrically controlled anti-peeping device 100H is not patterned, and the third electrode layer EL3 shown in FIG. 1 is not provided. The electrically controlled anti-peeping device 100H further includes a specially designed spacer disposed between the first substrate 101 and the second substrate 102. When the first electrode layer EL1-C and the second electrode layer EL2 are enabled, an anti-peeping pattern (as shown in FIG. 25) consisting of a plurality of dark areas DKA and a plurality of bright areas BTA alternately arranged can still be formed by the electrically controlled anti-peeping device 100H at the anti-peeping viewing angle. In other words, the anti-peeping pattern of the electrically controlled anti-peeping device 100H at the anti-peeping viewing angle of the embodiment is not defined by the electrode pattern. Specifically, the electrically controlled anti-peeping device 100H has, for example, a plurality of first regions and a plurality of second regions. The first region is, for example, a bright area BTA when the electrically controlled anti-peeping device 100H is enabled, and the second region is, for example, a dark area DKA when the electrically controlled anti-peeping device 100H is enabled; or the first region is a region where the coverage rate of the spacer on the substrate surface 101s of the first substrate 101 is relatively large (or relatively small), and the second region is a region where the coverage rate of the spacer on the substrate surface 101s of the first substrate 101 is relatively small (or relatively large).

Further, in the embodiment, the electrically controlled anti-peeping device 100H further includes a plurality of spacers. The material of the spacers includes, for example, a resin-type photoresist material or other elastic material, but the disclosure is not limited thereto. These spacers include a plurality of first spacers SP1 arranged in each bright area BTA and a plurality of second spacers SP2 arranged in each dark area DKA. It is particularly noted that an orthographic projection area of the plurality of first spacers SP1 on the substrate surface 101s of the first substrate 101 has a first ratio (for example, the coverage rate of the first spacer SP1 on each bright area BTA) relative to an orthographic projection area of each bright area BTA on the substrate surface 101s, and an orthographic projection area of the plurality of second spacers SP2 on the substrate surface 101s has a second ratio (for example, the coverage rate of the second spacer SP2 on each dark area DKA) relative to an orthographic projection area of each dark area DKA on the substrate surface 101s. The first ratio is different from the second ratio, and a ratio of the first ratio to the second ratio is, for example, greater than or equal to 1.5 (in one embodiment, the ratio is, for example, greater than or equal to 1.5 and less than or equal to 10). It is particularly noted that each bright area BTA is, for example, a range (the pitch of the spacers in the bright area BTA is the same or the difference is less than 5%) formed by the outer contour of an area where the adjacent plurality of first spacers SP1 (no second spacer SP2 is provided between the plurality of first spacers SP1) are located. As shown in FIG. 25, the outer contour of the area is, for example, a line connecting the outer edges of the peripheral first spacers SP1. The dark area DKA is, for example, an area between adjacent bright areas BTA.

In the embodiment, a first distribution density of the first spacers SP1 in each bright area BTA is different from a second distribution density of the second spacers SP2 in each dark area DKA. For example, in one direction (e.g., direction D1), the pitch between the plurality of first spacers SP1 is different from the pitch between the plurality of second spacers SP2. It should be noted first that the thickness of the liquid crystal layer LCL in each area formed after the assembly of the first substrate 101 and the second substrate 102 depends on the distribution density of the spacers. For example, when the distribution density of the spacers is high, a greater supporting force can be generated during the process of assembling and pressing the two substrates together, that is, the deformation amount of the spacers compressed by pressing the substrates and/or other components is small, so the spacing between the two substrates after assembly will also be larger.

For example, the first distribution density of the first spacers SP1 provided in a corresponding bright area BTA may be higher than the second distribution density of the second spacers SP2 provided in a corresponding dark area DKA. Therefore, a thickness t3 of the liquid crystal layer LCL overlapping each bright area BTA may be greater than a thickness t4 of the liquid crystal layer LCL overlapping each dark area DKA. However, the disclosure is not limited thereto. In other embodiments, the first distribution density of the first spacers SP1 in each bright area BTA may be lower than the second distribution density of the second spacers SP2 in each dark area DKA. That is, the thickness t3 of the liquid crystal layer LCL overlapping each bright area BTA may be less than the thickness t4 of the liquid crystal layer LCL overlapping each dark area DKA.

From another point of view, the transmittance of the electrically controlled anti-peeping device 100H at the anti-peeping viewing angle is related to the thickness of the liquid crystal layer LCL (the generated phase retardation). In other words, the dark areas DKA and the bright areas BTA required to form the anti-peeping pattern can be defined by adjusting the thickness of the liquid crystal layer LCL in different areas. In order to allow the thickness difference of the liquid crystal layer LCL to produce a more obvious brightness difference in the bright area BTA and the dark area DKA, a ratio of one of the first distribution density and the second distribution density to the other of the first distribution density and the second distribution density may be greater than or equal to 2 (in one embodiment, the ratio is, for example, greater than or equal to 2 and less than or equal to 10). For example, in the embodiment, the first distribution density of the first spacers SP1 in the bright area BTA to be formed may be more than twice the second distribution density of the second spacers SP2 in the dark area DKA to be formed.

In the embodiment, the first spacers SP1 and the second spacers SP2 are substantially the same in configuration (e.g., the difference in projection area is less than 5%), and the distribution density of the spacers is adjusted by changing the number of spacers disposed within a unit area.

However, the disclosure is not limited thereto. Referring to FIG. 26, in another embodiment of the electrically controlled anti-peeping device 100J, the configurations of the first spacer SP1-A and the second spacer SP2 may be different. More specifically, a first orthographic projection area of a single first spacer SP1-A on the substrate surface 101s of the first substrate 101 is different from a second orthographic projection area of a single second spacer SP2 on the substrate surface 101s. For example, the orthographic projection area of the spacer on the substrate surface 101s may be controlled by an exposure and development process, but the disclosure is not limited thereto.

On the other hand, in the electronically controlled anti-peeping device 100J, in one direction (e.g., direction D1), a plurality of first spacers SP1-A are arranged in each bright area BTA at intervals according to a first pitch P1, and a plurality of second spacers SP2 are arranged in each dark area DKA at intervals according to a second pitch P2. The first pitch P1 is substantially equal to the second pitch P2, and the pitch is, for example, the distance between the centers of the orthographic projection regions of adjacent spacers on the substrate surface 101s. In other words, regardless of whether in the bright area BTA or the dark area DKA to be formed, the number of spacers is substantially the same.

It is particularly noted that if the spacer has a larger orthographic projection area, in addition to having a higher height, it can also have better compressive resistance during the assembly process of the two substrates. Therefore, in the electrically controlled anti-peeping device 100J, in order to make the thickness t3 of the liquid crystal layer LCL in the bright area BTA greater than the thickness t4 of the liquid crystal layer LCL in the dark area DKA, the first orthographic projection area of the first spacer SP1-A may be greater than the second orthographic projection area of the second spacer SP2.

In order to allow the thickness difference of the liquid crystal layer LCL to produce a more obvious brightness difference in the bright area BTA and the dark area DKA, a ratio of one of the first orthographic projection area and the second orthographic projection area to the other of the first orthographic projection area and the second orthographic projection area may be greater than or equal to 1.5 (in one embodiment, the ratio is, for example, greater than or equal to 1.5 and less than or equal to 10). For example, in the electrically controlled anti-peeping device 100J, the first orthographic projection area of the first spacer SP1-A may be more than 1.5 times the second orthographic projection area of the second spacer SP2.

To sum up, in an electrically controlled anti-peeping device of an embodiment of the disclosure, when the first electrode layer and the second electrode layer used to drive the liquid crystal layer are enabled, the electrically controlled anti-peeping device will form an anti-peeping pattern composed of a plurality of bright areas and a plurality of dark areas at anti-peeping viewing angles. By configuring a third electrode layer or spacers of different arrangements to adjust the difference of phase retardations of the liquid crystal layer in the bright area and the dark area, the electrically controlled anti-peeping device of the embodiment of the disclosure has at least one of the following advantages: effectively improving the anti-peeping performance of the electrically controlled anti-peeping device, and simultaneously improving the visual quality of the user in the anti-peeping mode.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An electrically controlled anti-peeping device, comprising:
a first substrate, a second substrate, a liquid crystal layer, a first electrode layer, a second electrode layer, a third electrode layer, a first polarizer and a second polarizer, wherein
the first substrate and the second substrate are arranged overlapping each other,
the liquid crystal layer is disposed between the first substrate and the second substrate,
the first electrode layer and the third electrode layer are disposed on the first substrate, the second electrode layer is disposed on the second substrate, the third electrode layer is located between the first electrode layer and the first substrate, a projection region of the first electrode layer on the first substrate at least partially overlaps a projection region of the third electrode layer on the first substrate, and
the first polarizer and the second polarizer are respectively disposed on the first substrate and the second substrate.

2. The electrically controlled anti-peeping device according to claim 1, wherein when the first electrode layer and the second electrode layer are enabled, the electrically controlled anti-peeping device forms a plurality of bright areas and a plurality of dark areas, at least part of the plurality of bright areas and at least part of the plurality of dark areas are alternately arranged, and a phase retardation generated by the liquid crystal layer in each of the plurality of bright areas is different from a phase retardation generated by the liquid crystal layer in each of the plurality of dark areas.

3. The electrically controlled anti-peeping device according to claim 1, wherein the first electrode layer has a plurality of first electrode patterns electrically connected to each other and a plurality of first openings spaced apart from each other, the third electrode layer has a plurality of second electrode patterns electrically connected to each other and a plurality of second openings spaced apart from each other, the plurality of first electrode patterns respectively overlap the plurality of second openings, and the plurality of second electrode patterns respectively overlap the plurality of first openings.

4. The electrically controlled anti-peeping device according to claim 3, wherein the plurality of first electrode patterns partially overlap the plurality of second electrode patterns.

5. The electrically controlled anti-peeping device according to claim 3, further comprising:
an insulation layer, disposed between the first electrode layer and the third electrode layer, wherein a refractive index difference between the insulation layer and the third electrode layer is less than or equal to 0.3.

6. The electrically controlled anti-peeping device according to claim 1, wherein the first electrode layer has a plurality of first electrode patterns electrically connected to each other and a plurality of first openings spaced apart from each other, the electrically controlled anti-peeping device further includes a planarization layer disposed between the liquid crystal layer and the first electrode layer, the planarization layer directly covers the plurality of first electrode patterns and fills the plurality of first openings, and a refractive index difference between the planarization layer and the first electrode layer is less than or equal to 0.3.

7. The electrically controlled anti-peeping device according to claim 1, wherein the first electrode layer has a plurality of first electrode patterns electrically connected to each other and a plurality of first openings spaced apart from each other, and an orthographic projection of the plurality of first electrode patterns and the first openings on a substrate surface of the first substrate is located in an orthographic projection of the third electrode layer on the substrate surface.

8. The electrically controlled anti-peeping device according to claim 1, wherein the first electrode layer has a plurality of first electrode patterns electrically connected to each other and a plurality of first openings spaced apart from each other, the third electrode layer has a plurality of second electrode patterns electrically separated from each other, and the plurality of second electrode patterns are arranged along an anti-peeping control axial direction of the electrically controlled anti-peeping device and extend in a direction perpendicular to the anti-peeping control axial direction.

9. The electrically controlled anti-peeping device according to claim 1, wherein the first electrode layer has a plurality of first electrode patterns and a plurality of first openings, the first electrode layer is divided into a plurality of electrode portions electrically separated from each other, the plurality of electrode portions are arranged along an anti-peeping control axial direction of the electrically controlled anti-peeping device and extend in a direction perpendicular to the anti-peeping control axial direction, and each of the plurality of electrode portions is provided with a part of the plurality of first electrode patterns and a part of the plurality of first openings.

10. The electrically controlled anti-peeping device according to claim 1, provided with a first dimming zone and a second dimming zone located on two opposite sides of the first dimming zone and further comprising:
an insulation layer, disposed between the first electrode layer and the third electrode layer, wherein the first dimming zone and the second dimming zone are arranged along an anti-peeping control axial direction of the electrically controlled anti-peeping device, the insulation layer respectively has a first thickness and a second thickness in the first dimming zone and the second dimming zone, and the second thickness is less than the first thickness.

11. The electrically controlled anti-peeping device according to claim 1, wherein the first electrode layer has a plurality of first electrode patterns and a plurality of first openings, a plurality of dummy electrodes are disposed in the plurality of first openings, and the plurality of dummy electrodes are electrically separated from the first electrode layer.

12. The electrically controlled anti-peeping device according to claim 1, further comprising:
a first alignment layer, disposed between the first electrode layer and the liquid crystal layer and having a first alignment direction; and
a second alignment layer, disposed between the second electrode layer and the liquid crystal layer and having a second alignment direction, wherein an included angle between the first alignment direction and the second alignment direction is greater than or equal to 165 degrees and less than or equal to 195 degrees.

13. The electrically controlled anti-peeping device according to claim 12, wherein the first polarizer and the second polarizer respectively have a first absorption axis and a second absorption axis, an included angle between the first absorption axis and the second absorption axis is greater than or equal to 0 degrees and less than or equal to 15 degrees, and an axial direction of the first absorption axis is parallel to or perpendicular to the first alignment direction.

14. The electrically controlled anti-peeping device according to claim 1, further comprising:
a compensation film, disposed between the first polarizer or the second polarizer and the liquid crystal layer, wherein a sum of out-of-plane phase retardation of the compensation film is greater than or equal to 200 nm and less than or equal to 1000 nm.

15. An electrically controlled anti-peeping device, comprising a first substrate, a second substrate, a liquid crystal layer, a first electrode layer, a second electrode layer, a plurality of spacers, a first polarizer and a second polarizer, wherein
the first substrate and the second substrate are arranged overlapping each other,
the liquid crystal layer is disposed between the first substrate and the second substrate,
the first electrode layer and the second electrode layer are respectively disposed on the first substrate and the second substrate, the electrically controlled anti-peeping device has a plurality of first regions and a plurality of second regions, the plurality of first regions and the plurality of second regions are disposed at intervals,
the plurality of spacers are disposed between the first substrate and the second substrate and include a plurality of first spacers and a plurality of second spacers, each of the plurality of first regions is provided with the plurality of first spacers, each of the plurality of second regions is provided with the plurality of second spacers, an orthographic projection area of the plurality of first spacers on a substrate surface of the first substrate has a first ratio relative to an orthographic projection area of each of the plurality of first regions on the substrate surface, an orthographic projection area of the plurality of second spacers on the substrate surface has a second ratio relative to an orthographic projection area of each of the plurality of second regions on the substrate surface, the first ratio is different from the second ratio, and
the first polarizer and the second polarizer are respectively disposed on the first substrate and the second substrate.

16. The electrically controlled anti-peeping device according to claim 15, wherein a first distribution density of the plurality of first spacers in each of the plurality of first regions is different from a second distribution density of the plurality of second spacers in each of the plurality of second regions.

17. The electrically controlled anti-peeping device according to claim 16, wherein a ratio of the first distribution density to the second distribution density is greater than or equal to 2.

18. The electrically controlled anti-peeping device according to claim 15, wherein the plurality of first spacers are arranged in each of the plurality of first regions at intervals according to a first pitch, the plurality of second spacers are arranged in each of the plurality of second regions at intervals according to a second pitch, the first pitch is equal to the second pitch, and a first orthographic projection area of each of the plurality of first spacers on the substrate surface is different from a second orthographic projection area of each of the plurality of second spacers on the substrate surface.

19. The electrically controlled anti-peeping device according to claim 18, wherein a ratio of the first orthographic projection area to the second orthographic projection area is greater than or equal to 1.5.
